(19) United States
(12) Patent Application Publication
(10) Pub. No.: US 2026/0243213 A1
(43) Pub. Date: Aug. 20, 2026

(54) Internal Combustion Engine Control Device and Internal Combustion Engine Control Method

(71) Applicant: Astemo, Ltd., Chiyoda-ku, Tokyo (JP)

(72) Inventors: Shunsuke ARITOMI, Chiyoda-ku, Tokyo (JP); Masashi NEMOTO, Hitachinaka-shi, Ibaraki (JP); Osamu MUKAIHARA, Hitachinaka-shi, Ibaraki (JP); Toshihiro AONO, Chiyoda-ku, Tokyo (JP)

(21) Appl. No.: 19/162,131

(22) PCT Filed: Mar. 25, 2024
(86) PCT No.: PCT/JP2024/011658

§ 371 Date: Sep. 4, 2025

(30) Foreign Application Priority Data
May 15, 2023 (JP) 2023-079917

(51) Int. Cl. F02D 41/24; F02D 41/22

(52) U.S. Cl. CPC F02D 41/2464; F02D 41/221; F02D 2041/224; F02D 2200/0602

(57) ABSTRACT

An ECU includes a pressure change calculation unit which calculates a pressure change amount in the fuel pipe for each intermittent pressurization of the high-pressure fuel pump; an operation determination unit which determines an operation state of a solenoid valve of the fuel pump on the basis of the pressure change amount; and a current application amount learning unit, in the case where the operation state is determined as a failure of a valve closing operation of the solenoid valve, which changes a current application amount applied to the solenoid valve, and learns a lower limit value of a current application amount by which the valve closing operation of the solenoid valve can be performed.

### TECHNICAL FIELD

This invention relates to an internal combustion engine and an internal combustion engine control method.

### BACKGROUND ART

An internal combustion engine of an automobile is required to have high efficiency, low exhaustion, and high output. As means for achieving them in a balanced manner, it has been long since a direct internal combustion engine has been spread. Automobile manufacturers and suppliers have been always making efforts to improve product value. One of the important challenges is noise reduction of a high-pressure fuel pump. To reduce noise of a high-pressure fuel pump, it is sufficient to decrease the drive current of the high-pressure fuel pump. However, when the drive current is decreased excessively, the high-pressure fuel pump cannot discharge fuel. An optimum current application amount for noise reduction varies among individual high-pressure fuel pumps. In conventional noise reduction control on a high-pressure fuel pump, to check the minimum current application amount for each pump within the range in which discharge of fuel does not fail, the technique disclosed in the following Patent Literature 1 or the like is used.

As an example of a conventional noise reduction control on a pump, claim 1 of Patent Literature 1 discloses an invention of “a control device of a solenoid valve of a high-pressure fuel pump comprising a reduction unit which executes an operation sound reduction control for reducing an operation sound of a solenoid valve in an idle state of an internal combustion engine, wherein the reduction unit comprises: a first current unit which controls a drive current to a first current which can move an armature toward a stopper in a full open state of an inlet valve; a second current unit which controls, after supply of the first current, the drive current to a second current smaller than the first current; a third current unit which controls, after lapse of predetermined time since the second current is supplied, the drive current to a third current smaller than the second current; a determination unit which determines whether a valve closing operation of the inlet valve is insufficient or not; and a current control unit, when the determination unit determines that the valve closing operation is insufficient, increases only the second current out of the first, second, and third currents.

### CITATION LIST

### Patent Literature

Patent Literature 1: Japanese Unexamined Patent Application Publication No. 2017-53247

### SUMMARY OF INVENTION

### Technical Problem

In the method of controlling a solenoid valve of a high-pressure fuel pump described in Patent Literature 1, by reducing current (the second current in the technique described in Patent Literature 1), noise reduction is realized. However, when the current is reduced excessively, the valve closing operation becomes insufficient. Consequently, in the case where actual fuel pressure in an accumulation container decreases by a predetermined value or more from a target fuel pressure, the valve operation insufficiency is solved by increasing the current.

However, it is feared that, for example, in the case such that the operation condition of an internal combustion engine changes, although the valve operation is not insufficient, a transient change occurs in the fuel pressure, the actual fuel pressure decreases by a predetermined value or more from the target fuel pressure, and it is determined that the valve operation is insufficient. As a result, the current is not sufficiently reduced, and there is the possibility that the noise reduction efficiency decreases. The present invention, therefore, provides a method of controlling a high-pressure fuel pump to avoid the above-described problem.

The present invention is achieved in consideration of such circumstances, and an object of the present invention is to perform noise reduction control on a fuel pump.

### Solution to Problem

An internal combustion engine control device according to the present invention is an internal combustion engine control device for controlling an internal combustion engine including a fuel pump which intermittently pressurizes a fuel and discharges the fuel into a fuel pipe, and a fuel injection valve which injects the fuel intermittently pressurized, including: a pressure change calculation unit which calculates a pressure change amount in the fuel pipe for each intermittent pressurization of the fuel pump; an operation determination unit which determines an operation state of a solenoid valve of the fuel pump on the basis of the pressure change amount; and a current application amount learning unit, in the case where the operation state is determined as a failure of a valve closing operation of the solenoid valve, which changes a current application amount applied to the solenoid valve, and learns a lower limit value of a current application amount by which the valve closing operation of the solenoid valve can be performed.

### Advantageous Effects of Invention

According to the present invention, by determining the operation state of the solenoid valve on the basis of the pressure change amount for each intermittent pressurization, the operation state of the solenoid valve is determined with high precision. By using the determination result of the operation state, the lower limit value of a current application amount by which the valve closing operation of the solenoid valve can be performed is learned. Therefore, noise reduction control on the fuel pump can be performed. Objects, configurations, and effects other than the above will be apparent from the description of the following embodiments.

### BRIEF DESCRIPTION OF DRAWINGS

FIG. 1 is a diagram illustrating a schematic configuration of a direct internal combustion engine which is common to embodiments of the present invention.

FIG. 2 is a diagram illustrating a structure example of a high-pressure fuel pump which is common to the embodiments of the present invention.

FIG. 3 is a time chart for explaining the operation of the high-pressure fuel pump which is common to the embodiments of the present invention.

FIG. 4 is a diagram illustrating a configuration example of an ECU controlling a discharge rate of the high-pressure fuel pump which is common to the embodiments of the present invention.

FIG. 5A is a diagram illustrating an example of displacements of an inlet valve and an anchor in the case of a valve closure success common to the embodiments of the present invention.

FIG. 5B is a diagram illustrating an example of displacements of an inlet valve and an anchor in the case of a valve closure failure common to the embodiments of the present invention.

FIG. 6 is a diagram illustrating an example of fuel pipe pressures and plunger displacements at the valve closure success time and at the valve closure failure time.

FIG. 7 is a block diagram illustrating a configuration example of an ECU according to a first embodiment of the present invention.

FIG. 8 is a flowchart illustrating an operation example of the ECU according to the first embodiment of the present invention.

FIG. 9A is a diagram illustrating an example of fuel pressure changes in the case where closure of a solenoid valve fails and the fuel pressure decreases according to the first embodiment of the present invention.

FIG. 9B is a diagram illustrating an example of fuel pressure changes in the case where closure of a solenoid valve succeeds but the fuel pressure decreases according to the first embodiment of the present invention.

FIG. 10 is a block diagram illustrating an operation example of switching to a lower limit value as a learning value by the ECU according to the first embodiment of the present invention.

FIG. 11 is a diagram illustrating a state of a fuel pipe pressure in the case where fuel injection is performed in a pressurization period according to a second embodiment of the present invention.

### DESCRIPTION OF EMBODIMENTS

Hereinafter, an embodiment of the present invention will be described. However, the embodiment is not limited to embodiments illustrated in the drawings. In the specification and the drawings, repetitive description will be omitted by designating the same reference numeral to components having substantially the same function or configuration.

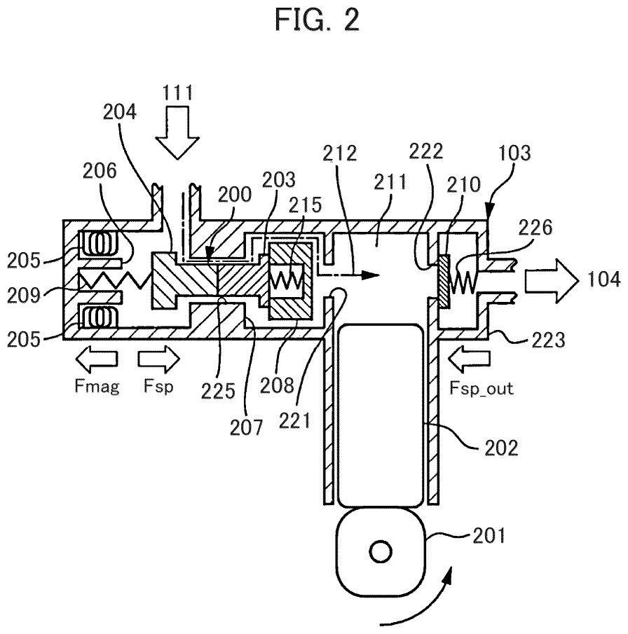

A control device according to each of embodiments of the present invention to be described hereinafter is applied to control of a high-pressure fuel pump of a normal-open type. In a high-pressure fuel pump of a normal-open type, a valve member (an inlet valve 203 in FIG. 2 which will be described later) is open when current is not passed to a solenoid, and the valve member closes when current is passed to the solenoid. In the high-pressure fuel pump of the normal-open type, by closing the valve member, fuel which is compressed by rise of a plunger is prevented from returning to a low-pressure pipe side, and the fuel is discharged to a high-pressure pipe side. In the following description, an example of controlling a fuel pump of a normal-open type by a control device according to each of the embodiments will be described. When valve closure and valve opening are replaced, by changing a current passing method, the device can be also applied to a pump of a normal-close type.

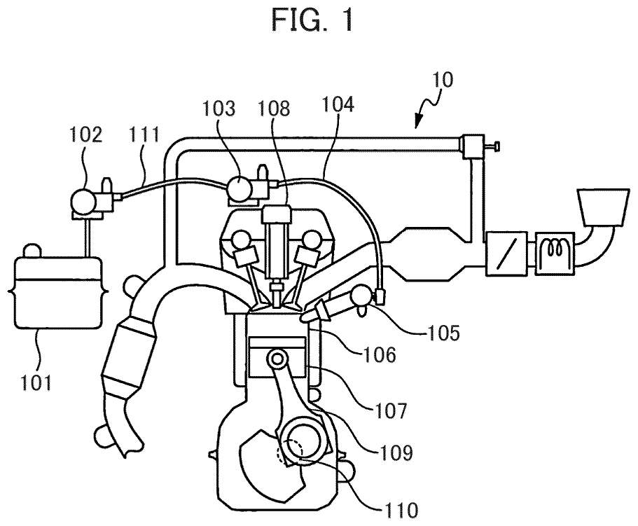

Prior to description of the control devices according to the first and second embodiments to which the present invention is applied, an example of the configuration and operation of a high-pressure fuel pump and a control device which are common to the embodiments will be described with reference to FIGS. 1 to 3.

### <<Summary of Internal Combustion Engine>>

FIG. 1 is a diagram illustrating a schematic configuration of a direct internal combustion engine 10.

In the direct internal combustion engine 10, fuel accumulated in a fuel tank 101 is pressurized to about a few atmospheres by a feed pump 102 and flows in a high-pressure fuel pump 103 via a low-pressure pipe 111. The fuel is further pressurized to tens MPa by the high-pressure fuel pump 103. The pressurized fuel passes through a high-pressure pipe 104 and is injected from a direct injector 105 to a cylinder 106 of the direct internal combustion engine 10.

The fuel injected into the cylinder 106 is mixed with air sucked in the cylinder 106 by the operation of a piston 107. The air-fuel mixture is ignited by a spark generated by an ignition plug 108 and explodes. The air-fuel mixture in the cylinder 106 expands by heat generated by the explosion and presses the piston 107 down. The force of pushing down the piston 107 rotates a crankshaft 110 via a link mechanism 109. The rotation of the crankshaft 110 is transmitted to wheels via a transmission and becomes power to move a vehicle.

Generally, an internal combustion engine is mainly required to have low fuel consumption, high output, and exhaust gas purification and, as further additional values, is required to reduce noise and vibration. In the high-pressure fuel pump 103, at the time of opening/closing an intake valve which intakes fuel, noise occurs when an anchor 204 (refer to FIG. 2) collides with a fixed part 206 and an inlet valve 203 collides with a seat part 207 or a stopper 208. Automobile manufacturers and suppliers are making great efforts to reduce the noise. Hereinafter, a structure example of the high-pressure fuel pump 103 as a control target of a control device according to the embodiment will be described.

### <<Configuration of High-Pressure Fuel Pump>>

FIG. 2 is a diagram illustrating a structure example of a high-pressure fuel pump 103.

The high-pressure fuel pump 103 illustrated in FIG. 2 is called a “high-pressure fuel pump of a normal-open type”. Although the normal-open type will be described in the embodiment, the present invention can be also applied to a normal-close type by replacing valve opening and valve closing.

A plunger 202 of the high-pressure fuel pump 103 moves upward and downward by the rotation of a cam 201 attached to the camshaft of the direct internal combustion engine 10. The inlet valve 203 opens/closes an inlet 225 when the anchor 204 is sucked by the fixed part 206 synchronously with the upward and downward motion of the plunger 202. A solenoid 205 which generates electromagnetic force when current I is passed controls the opening/closing operation of the inlet valve 203. The anchor 204 is sucked by a fixed core (fixed part 206) by electromagnetic force generated by the solenoid 205 and controls the operation of the inlet valve 203. The inlet valve 203 and the anchor 204 will be also called an electromagnetic actuator 200.

The high-pressure fuel pump 103 is surrounded by a casing 223, and a pressurization chamber 211 is disposed on the inside. The pressurization chamber 211 is a region of a range partitioned by a communication port 221 and an outlet 222. The fuel flows from the low-pressure pipe 111 side into the pressurization chamber 211 via the inlet 225 and the communication port 221. The fuel which flowed in the pressurization chamber 211 passes through the outlet 222 and is discharged to the high-pressure pipe 104 side.

The outlet 222 is opened/closed by a discharge valve 210. The discharge valve 210 is always energized in the direction of closing the outlet 222 by a spring part 226. When the pressure of the pressurization chamber 211 exceeds the spring force of the spring part 226, the outlet 222 is opened, and the fuel is discharged.

In the high-pressure fuel pump 103, by controlling the on or off state of energization of the solenoid 205, the operation in the axial direction (the lateral direction of FIG. 2) of the anchor 204 is controlled. The anchor 204 is always energized to the valve open direction (the right direction in FIG. 2) by a first spring 209 in a state where the energization of the solenoid 205 is off, and when the inlet valve 203 pressed by the anchor 204 comes into contact with the stopper 208 and enters a stationary state, the inlet valve 203 is maintained in an open position. FIG. 2 illustrates the state of the inlet valve 203 which is open. A dash-dotted line 212 in the diagram indicates the fuel inflow direction from the low-pressure pipe 111 to the pressurization chamber 211.

When the energization of the solenoid 205 is turned on, a magnetic attractive force Fmag is generated between the fixed part 206 (magnetic core) and the anchor 204. By the magnetic attractive force Fmag, the anchor 204 provided on the base end of the inlet valve 203 (the base part of the first spring 209) is sucked to the valve close direction (the left direction of FIG. 2) against a spring force Fsp of the first spring 209, and the anchor 204 is accelerated.

In a state where the anchor 204 is sucked by the fixed part 206, the inlet valve 203 serves as a check valve which opens/closes on the basis of the pressure difference between the upstream side and the downstream side and the energization force of a second spring 215. Therefore, when the pressure on the downstream side of the inlet valve 203 increases, the inlet valve 203 moves to the valve closing direction. When the inlet valve 203 moves only by a lift amount which is set in the valve closing direction, a projection of the inlet valve 203 seats on the seat part 207 and the inlet valve 203 enters a closed state, so that the fuel in the pressurization chamber 211 cannot flow back to the low-pressure pipe 111 side. Consequently, the fuel compressed by the rise of the plunger 202 passes through the outlet 222 and is discharged to the high-pressure pipe 104.

The operations of the high-pressure fuel pump 103 (mainly, energization to the solenoid 205 and movement of the anchor 204) are controlled by an ECU 114. To the ECU 114, operation information of the high-pressure fuel pump 103 (the rotation angle of the camshaft detected by the camshaft sensor, and the like), information detected by various sensors, and the like are input.

### <<Time Chart of Operation of the High-Pressure Fuel Pump>>

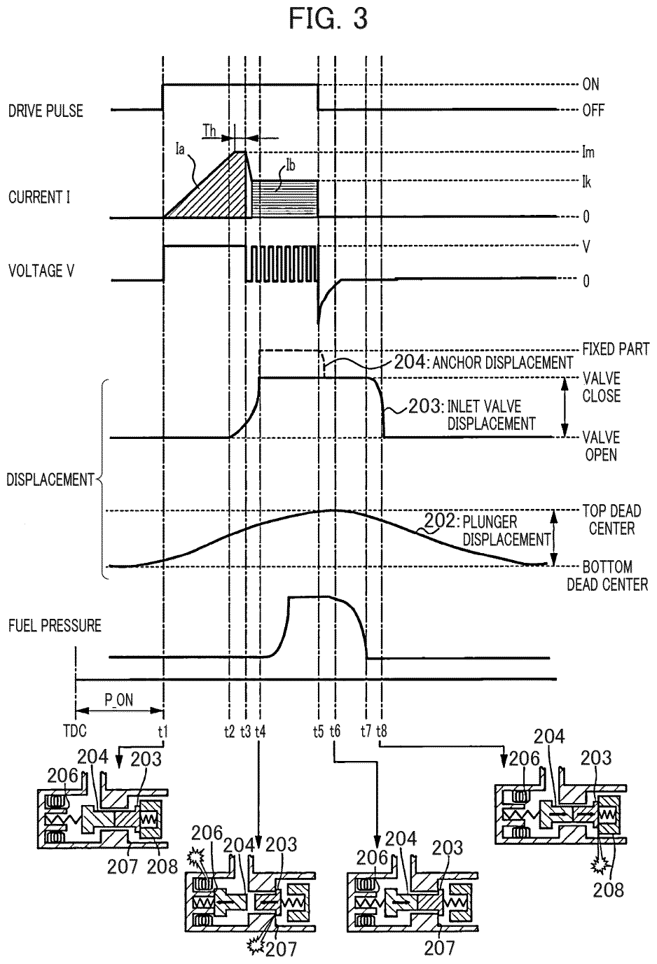

FIG. 3 is a time chart for explaining the operation of the high-pressure fuel pump 103. At the bottom of the time chart, the operation states of the high-pressure fuel pump 103 are illustrated in association with timings t1 to t8.

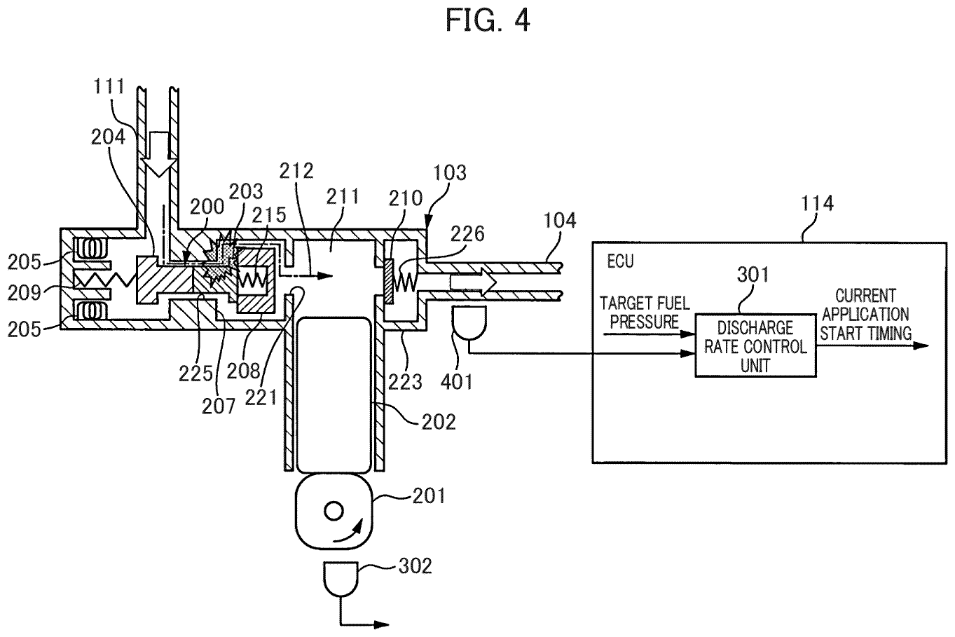

As illustrated in the uppermost stage of FIG. 3, a discharge rate control unit 301 (refer to FIG. 4 which will be described later) of the ECU 114 illustrated in FIG. 2 controls the discharge rate of the fuel discharged by the high-pressure fuel pump 103. For example, the ECU 114 detects the rotational angle of the camshaft so as to use it as a reference of opening/closing operation of the inlet valve 203 which is synchronous with the vertical movement of the plunger 202 (plunger displacement). For example, after the cam 201 turns by an angle (P_ON timing indicated in the left lower part of FIG. 3) determined from the top dead center (TDC), the discharge rate control unit 301 starts applying a voltage V indicated by the voltage waveform of FIG. 3 across the solenoid 205 from a not-illustrated power source (timing t1). At timing t1, a state where the anchor 204 is pressed against the inlet valve 203 by the energizing force of the first spring 209 is illustrated.

By the voltage V, the current I flowing in the solenoid 205 increases according to the following equation (1).

$$LdI / dt = V - RI \qquad ( 1 )$$

L in the equation (1) indicates inductance of the solenoid 205, and R expresses resistance of the wire. As the current I increases, the magnetic attractive force Fmag (refer to FIG. 2) which attracts the anchor 204 of the fixed part 206 (magnetic core) also increases.

When the magnetic attractive force Fmag becomes larger than the force Fsp of the first spring 209, the anchor 204 pressed by the spring force Fsp starts moving toward the fixed part 206 (timing t2). When the anchor 204 moves, by being pushed by the fuel pressurized by the rise of the plunger 202, the inlet valve 203 also moves toward the fixed part 206 so as to follow the anchor 204.

As illustrated in the graph of the current I in FIG. 3, the current I passed to the solenoid 205 is made by a peak current Ia for energization to start closing the inlet valve 203 which is in the stationary state and a holding current Ib which switches in a range lower than the maximum value of the peak current Ia in order to hold the inlet valve 203 in the closed state. Since the anchor 204 and the inlet valve 203 move by inertia, the ECU 114 controls the not-illustrated power source to so as to cut the peak current Ia before the inlet valve 203 is completely closed. The peak current Ia is cut at timing t3. In the following description, “completion of valve closure” means a timing at which the projection of the inlet valve 203 seats on the seat part 207 in the process of collision of the anchor 204 with the fixed part 206, and the inlet valve 203 closes. The peak current Ia indicated by the diagonal-line part in the current waveform in the diagram expresses current which is passed to the solenoid 205 to apply energization to close the valve to the inlet valve 203 and the anchor 204 which are pressed by the first spring 209 and are stationary at the valve open position.

After timing t3, the holding current Ib is passed to the solenoid 205. The holding current Ib indicate by the lateral-line part in the current waveform in the diagram expresses the current passed to the solenoid 205 by switching the voltage. The switching of the voltage is performed to attract the anchor 204 which approaches the fixed part 206 until the anchor 204 collides with the fixed part 206 and, after the collision, is performed to maintain the contact state. By the switching of the voltage, the current oscillates within a predetermined range.

Then, the projection provided at the front end of the inlet valve 203 collides with the seat part 207, and the inlet valve 203 seats. By the collision, the flow channel of the fuel indicated by the dash-dotted line 212 in FIG. 2 is closed (timing t4). The fuel pressurized by the rise of the plunger 202 cannot return to the low-pressure pipe 111 side, so that the pressure in the pressurization chamber 211 rises. Since the anchor 204 continues moving after the inlet valve 203 collides with the seat part 207, the displacement of the anchor 204 indicated by the broken line in the time chart becomes larger than the displacement of the inlet valve 203.

When the pressure in the pressurization chamber 211 becomes larger than a spring force Fsp out (refer to FIG. 2) of the spring part 226 which presses the discharge valve 210 and the pressure on the high-pressure pipe 104 side, the discharge valve 210 opens and the fuel pressurized by the rise of the plunger 202 is discharged to the high-pressure pipe 104. After that, the discharge rate control unit 301 applies inverse voltage to the solenoid 205 (timing t5). When the inverse voltage is applied, the holding current Ib supplied to the solenoid 205 is interrupted. Consequently, the anchor 204 starts moving in the right direction in FIG. 2 by being pushed by the force of the first spring 209 which becomes larger than the magnetic attractive force.

As illustrated in the fifth stage from the top of FIG. 3, when the plunger 202 starts descending after the cam angle reaches the top dead center (timing t6), the fuel pressure in the pressurization chamber 211 starts decreasing as illustrated in the sixth stage from the top of FIG. 3. When the fuel pressure becomes smaller than the spring force Fsp out of the spring part 226 and the pressure on the high-pressure pipe 104 side, the discharge valve 210 closes and the discharge of the fuel is finished (timing t7).

By the decrease in the fuel pressure of the pressurization chamber 211, the anchor 204 moves from the valve close position to the valve open position together with the inlet valve 203 (timings t7 and t8).

By such an operation, the high-pressure fuel pump 103 sends the fuel from the low-pressure pipe 111 to the high-pressure pipe 104. In this process, main noise occurs when the anchor 204 collides with the fixed part 206 after the valve closure completion (timing t4 in FIG. 3) and when the anchor 204 and the inlet valve 203 collide with the stopper 208 and the valve opening completes (timing t8 in FIG. 3).

Particularly, the noise when the anchor 204 collides with the fixed part 206 is large. The noise may make the driver unpleasant particularly at the time of idling, and the automobile manufacturers and suppliers of high-pressure fuel pumps are challenging to reduce the noise. The ECU 114 according to the embodiment was invented, particularly, for the purpose of reducing noise which occurs at the time of valve closure completion (timing t4 in FIG. 3).

### <<Peak Current Ia and Holding Current Ib>>

The current passed to the solenoid 205 to perform the control to reduce noise of the driving of the high-pressure fuel pump 103 by the ECU 114 will be described.

As described above, the current which drives the high-pressure fuel pump 103 is roughly divided into two currents; the peak current Ia (the diagonal-line part of the current waveform in FIG. 3) and the holding current Ib (the lateral-line part of the current waveform in FIG. 3). By integrating the peak current Ia in the period from the timing t1 to the timing t3 illustrated in FIG. 3, a peak current integral value is calculated. The peak current integral value is defined by an integral value of the current I passed to the solenoid 205 from the timing t1 of the start of supply of the peak current Ia illustrated in FIG. 3 to the timing t3 at which decrease of the peak current Ia starts.

The peak current Ia is passed to the solenoid 205 in order to apply energization for valve closing to the inlet valve 203 and the anchor 204 which are stationary at the valve open position by being pressed by the first spring 209. Consequently, when the peak current integral value is decreased, the valve closing force weakens, and the noise can be reduced.

On the other hand, the holding current Ib attracts the anchor 204 which approaches the fixed part 206 until the anchor 204 collides with the fixed part 206 and, after the anchor 204 collides with the fixed part 206, the contact state of the anchor 204 is maintained. When the peak current application amount can be decreased, the force of the valve closing weakens, and the noise can be reduced. However, when the peak current application amount is excessively decreased, valve closing fails. It is therefore required to decrease the peak current application amount as much as possible within the range in which the valve is closed.

### <<Discharge Rate Control Unit>

FIG. 4 is a diagram illustrating a configuration example of an ECU controlling a discharge rate of the high-pressure fuel pump 103.

The high-pressure pipe 104 is provided with a fuel pressure sensor 401. The fuel pressure sensor 401 has the function of measuring the fuel pressure in the high-pressure pipe 104.

The discharge rate control unit 301 is provided for the ECU 114, and has the function of controlling the discharge rate of the high-pressure fuel pump 103. Consequently, to the discharge rate control unit 301, a target fuel pressure and a fuel pressure measurement value measured by the fuel pressure sensor 401 are input. A rotational angle sensor 302 measures the rotational angle of the cam 201. The information of the rotational angle is output to the ECU 114.

The role of the high-pressure fuel pump 103 is to compress the fuel in the low-pressure pipe 111 and discharge the compressed fuel to the high-pressure pipe 104 so as to maintain the fuel pressure in the high-pressure pipe 104 to a target value. Consequently, the discharge rate control unit 301 controls the current application start timing of current which is applied to the solenoid 205 so that the fuel pressure measurement value in the high-pressure pipe 104 measured by the fuel pressure sensor 401 follows the target fuel pressure.

In the case where it is determined that the fuel pressure measurement value is lower than the target fuel pressure, the discharge rate control unit 301 controls the discharge rate so that the fuel pressure reaches the target fuel pressure by advancing the current application start timing to increase the discharge rate of the fuel. On the other hand, in the case where it is determined that the fuel pressure measurement value is higher than the target fuel pressure, the discharge rate control unit 301 controls so that the fuel pressure becomes lower than the target fuel pressure by retarding the current application start timing to decrease the discharge rate of the fuel. Generally, in the discharge rate control unit 301, a PID (Proportional-Integral-Differential) control is applied.

### <Noise Reduction Control>

As the peak current Ia and the holding current Ib have been described, when the ECU 114 decreases the peak current application amount, the speed at the time of closing the valve member (inlet valve) is lowered, and noise reduction is realized.

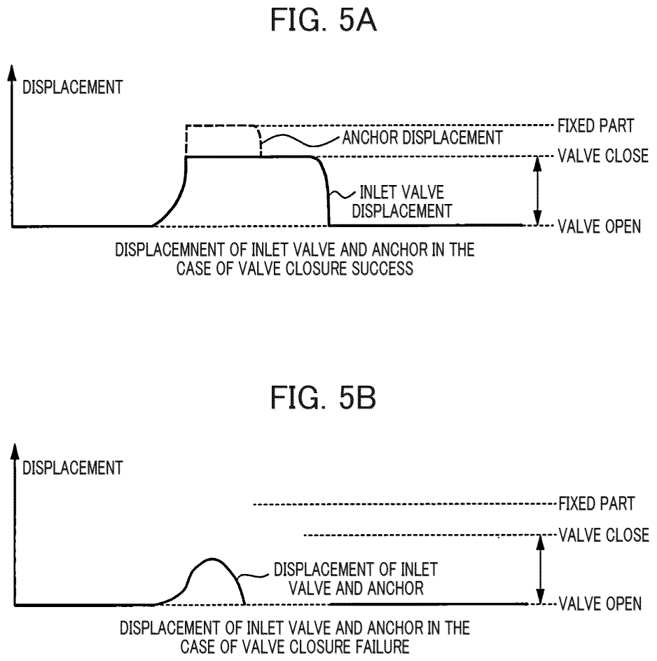

FIG. 5A and FIG. 5B are diagrams illustrating an example of displacements of the inlet valve 203 and the anchor 204 (refer to FIG. 4).

FIG. 5A is a diagram illustrating an example of displacements of the inlet valve 203 and the anchor 204 in the case of a valve closure success. FIG. 5A is the same as the graph of the displacement of the valve member of the inlet valve 203 and the anchor 204 at the time of the valve closure success illustrated in FIG. 3.

As illustrated in FIG. 5A, when the ECU 114 supplies sufficient current to the solenoid 205, the inlet valve 203 and the anchor 204 move, and valve closure succeeds.

FIG. 5B is a diagram illustrating an example of displacements of the inlet valve 203 and the anchor 204 in the case of a valve closure failure.

The more the peak current application amount is decreased, the more the sound of collision of the inlet valve 203 and the anchor 204 is suppressed. Consequently, the ECU 114 can reduce noise of the high-pressure fuel pump 103. However, when the ECU 114 decreases the peak current application amount excessively, valve closure fails. As illustrated in FIG. 5B, when the ECU 114 supplies only an insufficient peak current application amount, the magnetic attractive force Fmag is weaker than the spring force Fsp, so that the valve closing operation of the inlet valve 203 and the anchor 204 fails.

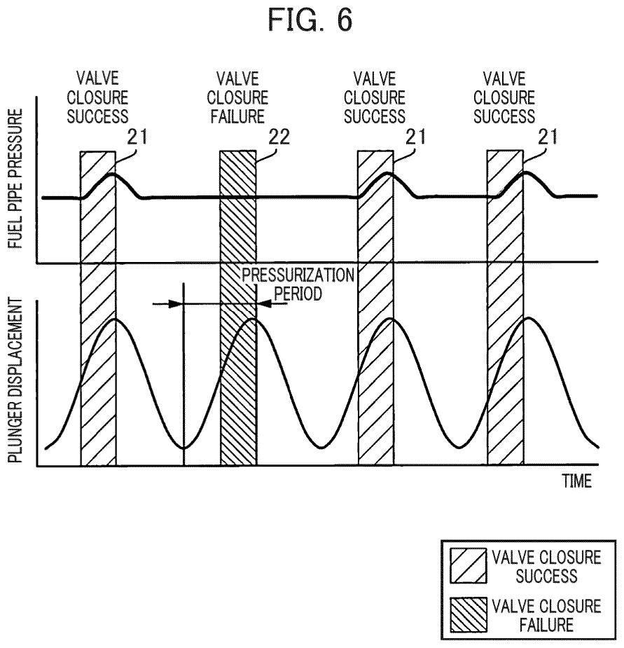

FIG. 6 is a diagram illustrating an example of the fuel pipe pressure (hereinafter, simply described as “fuel pressure”) and plunger displacement at the valve closure success time and the valve closure failure time. The upper part of FIG. 6 illustrates a state of changes in the fuel pressure, and the lower part of FIG. 6 illustrates a state of plunger displacement. The period in which the plunger 202 moves from the bottom dead center to the top dead center will be called a pressurization period.

At the valve closure success time, the valve member closes the flow channel extending from the pressurization chamber 211 to the low-pressure pipe 111. Consequently, the pressure rise in the pressurization chamber 211 due to the rise of the plunger 202 propagates to the high-pressure pipe 104. When the valve closure succeeds, the pressure in the high-pressure pipe 104 rises as illustrated by a region 21 (positively sloped line region) synchronously with the rise of the plunger 202 by propagation of the pressure rise. On the other hand, when the valve closure fails, even when the plunger 202 rises, the fuel in the pressurization chamber 211 escapes to the low-pressure pipe 111. Consequently, as illustrated by a region 22 (negatively sloped line region), the pressure of the high-pressure pipe 104 does not rise.

The discharge rate control unit 301 illustrated in FIG. 4 identifies the difference of the pressure in the high-pressure pipe 104 on the basis of the pressure measurement value of the fuel pressure sensor 401 disposed in the high-pressure pipe 104 or a common rail (not illustrated), and performs determination of the operation of the solenoid valve (the inlet valve 203 and the anchor 204). Using the operation determination result of the solenoid valve, the discharge rate control unit 301 decreases the current application amount when the closure of the solenoid valve succeeds, and adds the current application amount when the closure of the solenoid valve fails. The discharge rate control unit 301 sets the decreased or added current application amount to a lower limit value at which the valve closing operation of the solenoid valve can be performed. After that, the discharge rate control unit 301 controls the current application amount to the lower limit value under the operation condition in which noise reduction in the high-pressure fuel pump 103 is desired, thereby reducing noise at the time of valve closure of the high-pressure fuel pump 103.

### First Embodiment

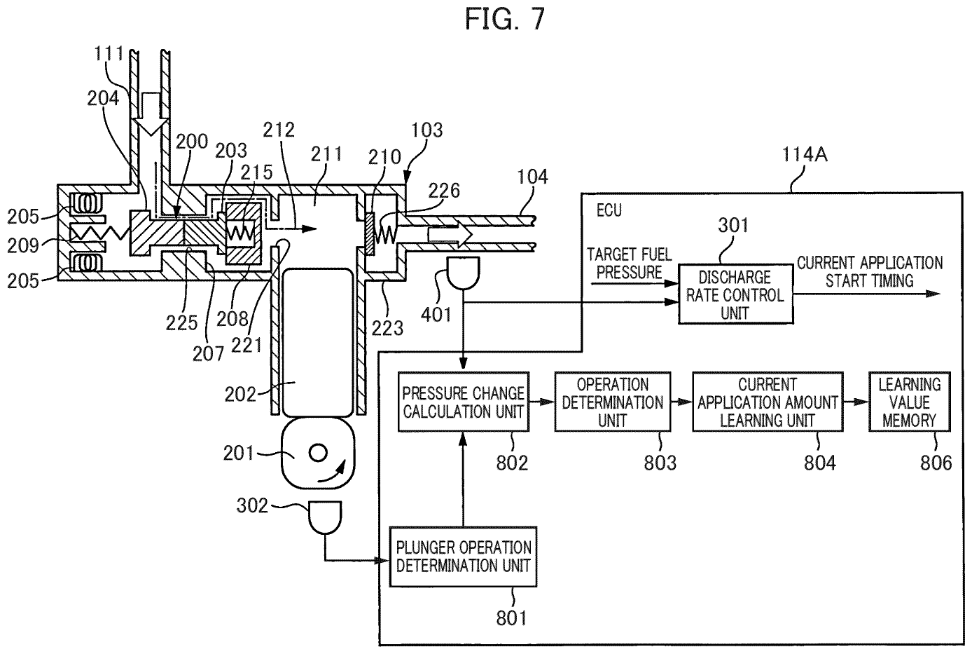

A first embodiment for executing noise reduction control on the high-pressure fuel pump 103 will be described by being divided to a mode of learning the current application amount by an ECU 114A and a mode of using a learning value. Since the pulsation of the fuel pressure synchronized with the rise of the plunger 202 has to be detected, the noise reduction control of the high-pressure fuel pump 103 has to be executed in a sufficiently shorter cycle in which the pulsation can be detected. The ECU 114A illustrated in FIG. 7 is obtained by adding components necessary for the control of the first embodiment to the ECU 114 illustrated in FIG. 4.

### (Mode of Learning Current Application Amount by ECU)

First, a mode of learning a current application amount by the ECU 114A according to the first embodiment will be described.

FIG. 7 is a block diagram illustrating a configuration example of the ECU 114A. In FIG. 7, the high-pressure fuel pump 103 is also illustrated together with the ECU 114A.

As illustrated in FIG. 7, the ECU 114A according to the first embodiment controls the operation of an internal combustion engine (direct internal combustion engine 10) having a fuel pump (high-pressure fuel pump 103) which intermittently pressurizes fuel and discharges it into a fuel pipe (high-pressure pipe 104) and a fuel injection valve (direct injector 105 illustrated in FIG. 1) for injecting the intermittent-pressurized fuel. The ECU 114A has, in addition to the discharge rate control unit 301 illustrated in FIG. 4, a plunger operation determination unit 801, a pressure change calculation unit 802, an operation determination unit 803, a current application amount learning unit 804, and a learning value memory 806.

The plunger operation determination unit 801 determines the operation of the plunger 202 (for example, the phase angle of the plunger 202) on the basis of the crank angle calculated from the rotational angle sensor 302.

The pressure change calculation unit (pressure change calculation unit 802) calculates a pressure change amount in the fuel pipe (high-pressure pipe 104) for each intermittent pressurization of the fuel pump (high-pressure fuel pump 103). The pressure change calculation unit (pressure change calculation unit 802) uses a signal synchronized with the rotation phase of the camshaft which drives the fuel pump (high-pressure fuel pump 103) as an input value, and calculates the pressure change amount for each intermittent pressurization of the fuel pump (high-pressure fuel pump 103). In the embodiment, a signal synchronized with the rotation phase of the camshaft which drives the high-pressure fuel pump 103 is a crank angle calculated from the rotational angle sensor 302. Consequently, the pressure change calculation unit 802 can calculate the pressure change amount synchronously with the operation of the plunger 02 connected to the camshaft.

The operation determination unit (operation determination unit 803) determines the operation state of the solenoid valve of the fuel pump (high-pressure fuel pump 103) on the basis of the pressure change amount. The operation determination unit (operation determination unit 803) can determine insufficiency of the closing operation of the solenoid valve as the operation state of the solenoid valve. The determination result of the operation state of the solenoid valve by the operation determination unit 803 is output to the current application amount learning unit 804.

When the operation state is determined as a failure of the closing operation of the solenoid valve, the current application amount learning unit (current application amount learning unit 804) changes the current application amount applied to the solenoid valve and learns the lower limit value of the current application amount by which the closing operation of the solenoid valve can be performed. The current application amount learning unit (current application amount learning unit 804) preliminarily learns the lower limit value in the period in which the internal combustion engine (direct internal combustion engine 10) is operated. The period in which the internal combustion engine (direct internal combustion engine 10) is operated includes, for example, the general state where the direct internal combustion engine 10 is driven and includes not only a state where the vehicle travels but also a state where the vehicle stops.

The current application amount learning unit (current application amount learning unit 804) preliminarily learns the lower limit value in the period in which the internal combustion engine (direct internal combustion engine 10) is in steady operation. The period in which the internal combustion engine (direct internal combustion engine 10) is in steady operation includes, for example, an idling state and a state where the vehicle travels at constant speed.

The learning value memory 806 stores the lower limit value of the current application amount learned by the current application amount learning unit 804.

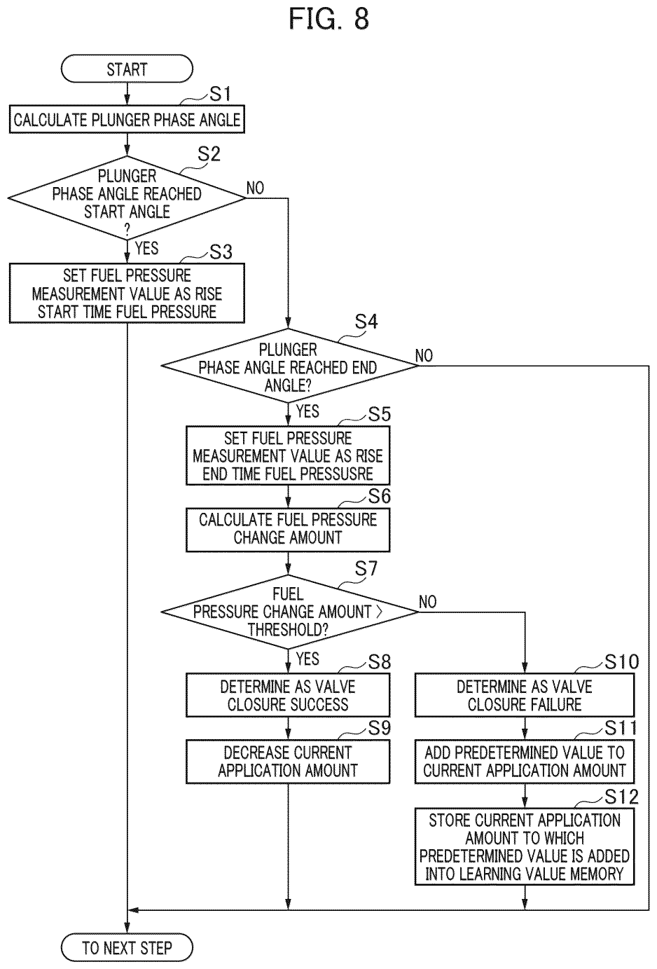

FIG. 8 is a flowchart illustrating an operation example of the ECU 114A according to the first embodiment.

When the learning of the lower limit value of the current application amount starts, the plunger operation determination unit 801 calculates the phase angle of the plunger 202 on the basis of the phase difference between the crank angle calculated from the rotational angle sensor 302 and the cam angle received from the not-illustrated variable valve mechanism control device (S1). The phase angle of the plunger 202 calculated by the plunger operation determination unit 801 is output to the pressure change calculation unit 802.

The pressure change calculation unit 802 calculates the pressure change on the basis of the phase angle of the plunger 202, and determines whether or not the phase angle of the plunger 202 reaches the start angle of the fuel pressure change calculation range which is set in advance (S2). When the phase angle of the plunger 202 reaches the start angle of the fuel pressure change calculation range which is set in advance (YES in S2), the pressure change calculation unit 802 sets the fuel pressure measurement value as the fuel pressure at the rise start time of the plunger 202 (S3). After that, the program advances to the next step, that is, the mode of using a learning value.

On the other hand, when it is determined in step S2 that the phase angle of the plunger 202 does not reach the start angle of the fuel pressure change calculation range which is set in advance (NO in S2), the pressure change calculation unit 802 determines whether or not the phase angle of the plunger 202 reaches the end angle of the fuel pressure change calculation range which is set in advance (S4). When it is determined that the phase angle of the plunger 202 does not reach the end angle of the fuel pressure change calculation range which is set in advance (NO in S4), the pressure change calculation unit 802 moves to the next step, that is, the mode of using a learning value.

On the other hand, when it is determined in step S4 that the phase angle of the plunger 202 reaches the end angle of the fuel pressure change calculation range which is set in advance (YES in S4), the pressure change calculation unit 802 sets the fuel pressure measurement value as the fuel pressure at the rise end time of the plunger 202 (S5). Subsequently, the pressure change calculation unit 802 calculates a fuel pressure change amount as a change amount of the fuel pressure by subtracting the fuel pressure at the rise start time from the fuel pressure at the rise end time (S6), and outputs the fuel pressure change amount to the operation determination unit 803.

Then, the operation determination unit 803 determines whether the fuel pressure change amount is larger than a threshold or not (S7).

When it is determined that the fuel pressure change amount is larger than the threshold (YES in S7), the operation determination unit 803 determines it as a valve closure success (S8). Subsequently, the discharge rate control unit 301 decreases the current application amount (S9), operates the solenoid valve and, after that, moves to the next step.

In the case where it is determined in step S7 that the fuel pressure change amount is equal to or less than the threshold (NO in S7), the operation determination unit 803 determines it as a valve closure failure (S10). Consequently, the discharge rate control unit 301 adds a predetermined value to the current application amount (S11) and operates the solenoid valve. After that, the current application amount learning unit 804 stores the current application amount to which the predetermined value is added in the learning value memory 806 (S12). After that, the program advances to the next step, that is, the mode of using a learning value.

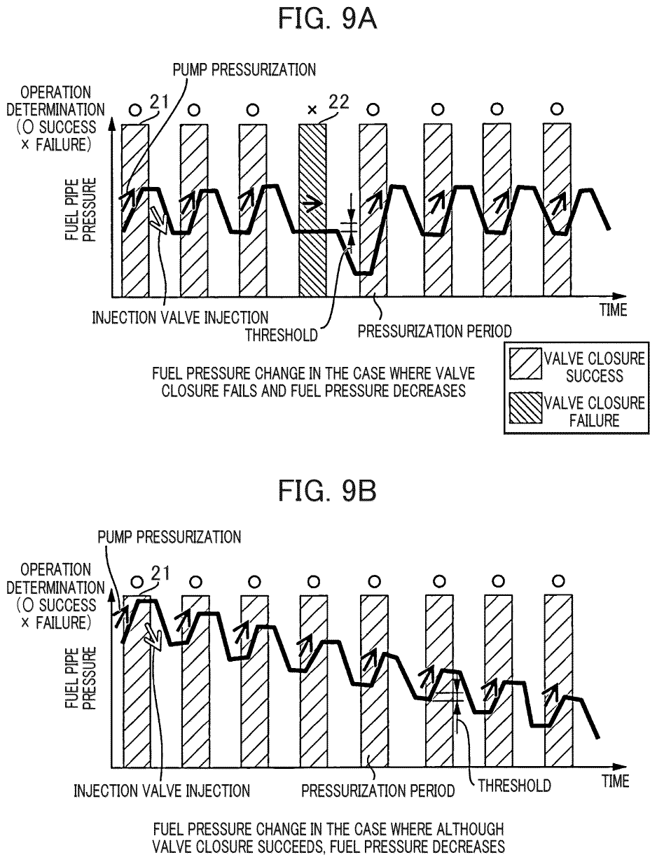

FIGS. 9A and 9B are conceptual diagrams of determination results of the valve closing operation when the process of the ECU 114A according to the first embodiment is executed. In the graphs illustrated in FIGS. 9A and 9B, the horizontal axis indicates time, and the vertical axis indicates the fuel pipe pressure. In the following diagrams, as results of determination of the valve closing operation, the valve closure success is expressed by a circle mark, and the valve closure failure is expressed by a cross mark.

The operation determination unit 803 illustrated in FIG. 7 divides the operation state of the solenoid valve into two kinds on the basis of changes in the fuel pressure calculated every pressurization period of the high-pressure fuel pump 103 by the pressure change calculation unit 802, and makes determination. In FIGS. 9A and 9B, in a manner similar to FIG. 6, the operation determination result of the valve closure success is expressed by the region 21, and the operation determination result of the valve closure failure is expressed by the region 22.

FIG. 9A is a diagram illustrating an example of the case where closing of the solenoid valve fails and the fuel pressure decreases. In the case of valve closure success, operations in which when the high-pressure fuel pump 103 is pressurized, the fuel pressure increases, and when the fuel is injected from the fuel injection valve, the fuel pressure decreases are repeated every pressurization period. However, in the case of valve closure failure, even at the timing the high-pressure fuel pump 103 is pressurized, the fuel pressure does not increase. When the fuel is injected from the fuel injection valve, the fuel pressure further decreases.

FIG. 9B is a diagram illustrating an example of the case where the fuel pressure decreases in spite of success in closure of the solenoid valve. In this example, the operations in which the high-pressure fuel pump 103 is pressurized and the fuel is injected from the fuel injection valve are normal, and the closure of the solenoid valve succeeds in each pressurization period. In the high-pressure fuel pump 103, the fuel pressure decreases each time the series of operations are performed. Such a change in the fuel pressure occurs, for example, when the vehicle is in the idling state.

(Mode in which ECU Switches Predetermined Value and Learning Value)

The ECU 114A switches a predetermined value and a learning value in accordance with differences in the above-described operation states of the solenoid valve.

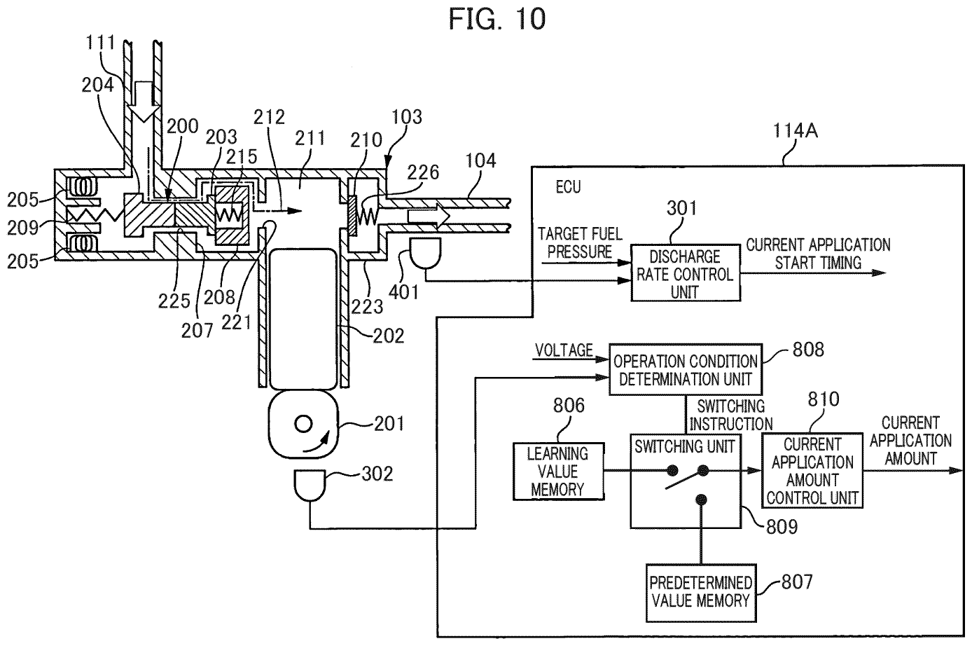

FIG. 10 is a block diagram illustrating an operation example of switching to a lower limit value as a learning value by the ECU 114A. The ECU 114A performs a process of reflecting a learning value (limit value) of the learning value memory 806 into the control of the current application amount at the time of valve closure failure.

As illustrated in FIG. 10, the ECU 114A has the components of the ECU 114A according to the first embodiment illustrated in FIG. 7 and, in addition, a predetermined value memory 807, an operation condition determination unit 808, a switching unit 809, and a current application amount control unit 810. A part of the components of the ECU 114A according to the first embodiment illustrated in FIG. 7 is omitted here.

The operation condition determination unit (operation condition determination unit 808) has the function of determining the operation condition of the direct internal combustion engine 10 operated by the fuel pump (high-pressure fuel pump 103). When the operation condition determination unit 808 determines a preliminarily set operation condition in which noise reduction is desired, a switching command is output to the switching unit 809. The switching command is a command to change a current application amount which is output from the current application amount control unit 810 from a predetermined value stored in the predetermined value memory 807 to a lower limit value as a learning value stored in the learning value memory 806. After that, when the operation condition changes, the switching command is output to the switching unit 809 so that the switching unit 809 reads a predetermined value from the predetermined value memory 807. At the time of valve closure failure, by switching to a lower limit value at which the operation of closing the solenoid valve is possible, the operation of closing the solenoid valve can be performed.

In the period in which the operation condition determination unit (operation condition determination unit 808) determines that the fuel pump (high-pressure fuel pump 103) is operated under the noise reduction operation condition, the switching unit (switching unit 809) changes the current application amount of the solenoid valve from a predetermined control value to a lower limit value. At this time, the switching unit 809 reads either a learning value stored in the learning value memory 806 or a learning value stored in the predetermined value memory 807 and outputs it to the current application amount control unit 810. Usually, the switching unit 809 outputs a predetermined value read from the predetermined value memory 807 to the current application amount control unit 810. However, when a switching command is input so as to read a learning value from the operation condition determination unit 808, the switching unit 809 outputs a learning value read from the learning value memory 806 to the current application amount control unit 810. After that, when a switching command is input so as to read a predetermined value from the operation condition determination unit 808, the switching unit 809 outputs a predetermined value read from the predetermined value memory 807 to the current application amount control unit 810.

By applying a current application amount according to the read predetermined value or learning value switched by the switching unit 809 to the solenoid 205, the current application amount control unit 810 controls the operation of the high-pressure fuel pump 103.

By the mode illustrated in FIG. 10, the ECU 114A can control the current application amount around the minimum value at which closure of the solenoid valve succeeds, reduce noise, and operate the high-pressure fuel pump 103.

The ECU 114A does not always change the current application amount but switches to the lower limit value as a learning value which is preliminarily learned only under the operation condition in which the noise of the high-pressure fuel pump 103 is desired to be reduced. By the above, the valve of the high-pressure fuel pump 103 can be reliably closed in the pressurization period, and the stable control of the high-pressure fuel pump 103 can be realized. For the control of the high-pressure fuel pump 103, for example, learning of the lower limit value is performed at the time of steady operation such as the idling time of the direct internal combustion engine 10.

Generally, in the case where the operation condition of the direct internal combustion engine 10 is idling, noise other than the high-pressure fuel pump 103 is small, so that the operation sound of the high-pressure fuel pump 103 is conspicuous. Consequently, the noise reduction at the time of idling often becomes an important challenge. By performing learning at the time of idling as the operation condition of reducing noise in the high-pressure fuel pump 103, the ECU 114A can therefore perform higher-precision noise reduction control when the operation condition at the time of learning and the operation condition under which the noise reduction control is actually performed match. During the steady operation of the vehicle, the fuel pressure also behaves cyclically. Consequently, an effect of improving the precision of operation determination of the solenoid valve by the operation determination unit 803 can be also expected.

Further, it is expected that the lower limit value of the current application amount is influenced by the voltage supplied to the solenoid valve. Therefore, the current application amount learning unit (current application amount learning unit 804) preliminarily learns a lower limit value under a plurality of voltage conditions of the internal combustion engine (direct internal combustion engine 10). In the case where the operation condition determination unit (operation condition determination unit 808) determines that the fuel pump (high-pressure fuel pump 103) is operated under the noise reduction operation condition, the switching unit (switching unit 809) changes the current application amount of the solenoid valve from a predetermined control value to a lower limit value according to the voltage condition. When the high-pressure fuel pump 103 is operated under the noise reduction operation condition as described above, the current application amount control unit 810 uses the lower limit value according to the voltage detected at the time of controlling the high-pressure fuel pump 103, thereby suppressing collision speed of the valve member, and can further increase the noise reduction effect of the high-pressure fuel pump 103.

As a concern at the time of controlling the current application amount as the lower limit value, responsiveness lowering of the solenoid valve can be mentioned. As a result of responsiveness lowering, it is concerned that the discharge rate changes at the same current application start timing. As a countermeasure, the ECU 114A may determine the current application start timing in consideration of a response delay at the time of decreasing the current application amount.

In the above-described ECU 114A according to the first embodiment, the operation state of the solenoid valve can be determined with high precision by determining the operation state of the solenoid valve on the basis of a pressure change amount for each intermittent pressurization in the high-pressure pipe 104 measured by the existing fuel pressure sensor 401. The fuel pressure decrease due to insufficient valve operation and pressure decrease due to an operation condition change or the like can be separated. For example, the ECU 114A can separate the case where the valve closure fails and the fuel pressure decreases and the case where the valve closure succeeds but the fuel pressure decreases. Conventionally, the control to change the current application amount in accordance with the operation condition is not executed. In contrast, when the case where the valve closure fails and the fuel pressure decreases is determined, the ECU 114A controls so as to increase the current application amount. Consequently, the ECU 114A can realize reduction in the noise of the high-pressure fuel pump 103 by applying the lower limit value of the current application amount which can reliably make the valve closure succeed to the solenoid 205.

In the case where the change amount of the fuel pressure in the high-pressure pipe 104 calculated for each pressurization section in the high-pressure fuel pump 103 is less than a threshold, the ECU 114A can determine a valve closure failure. Consequently, after determination of the valve closure failure, by applying the lower limit value of the current application amount which is preliminarily learned to the solenoid 205, the ECU 114A can make the valve closure successful in the following pressurization section. Since the current application amount is controlled by the lower limit value, the current application amount control unit 810 can perform noise reduction control on the high-pressure fuel pump 103 while sufficiently decreasing the current.

The current application amount learning unit 804 preliminarily learns the lower limit value of the current application amount by which the valve closing operation can be performed. The lower limit value of the current application amount is learned for each of individual high-pressure fuel pumps 103. Consequently, as compared with the case where a predetermined current application amount is applied to the solenoid 205 regardless of differences in individual high-pressure fuel pumps 103 like in the conventional case, a current application amount of a proper lower limit value according to each of individual high-pressure fuel pumps 103 can be applied to the solenoid 205.

The ECU 114A can reduce noise at the time of valve closure of the high-pressure fuel pump 103 by continuously controlling the current application amount to the learned lower limit value even in the state where the fuel pressure in the high-pressure pipe 104 decreases little by little with lapse of time of the high-pressure fuel pump 103.

The operation determination unit 803 determines a valve closure success when the fuel pressure change amount is larger than the threshold, and determines a valve closure failure when the fuel pressure change amount is less than the threshold. By providing the threshold in such a manner, even in the case where a fuel pressure change amount is generated due to pulsation or the like despite occurrence of a valve closure failure, the operation determination unit 803 can reliably determine a failure in valve closure.

In the case where valve closure fails even though the current application amount control unit 810 controls the current application amount by a learning value under the noise reduction operation condition, the switching unit 809 may switch so as to read a predetermined value from the predetermined value memory 807. In this case, the current application amount control unit 810 controls the current application amount by a predetermined value, so that the valve closure can certainly succeed.

### Second Embodiment: Fuel Injection is Performed in Pressurization Period

An operation example of the ECU 114A according to a second embodiment of the present invention will now be described. In the second embodiment, a control example of reducing noise in the high-pressure fuel pump 103 in the case where fuel injection is performed in a pressurization period of the high-pressure fuel pump 103 in accordance with an operation condition of the direct internal combustion engine 10 will be described.

A camshaft which drives the high-pressure fuel pump 103 is a shaft different from the crankshaft interlocked with the fuel cycle. There is also a case where a variable valve mechanism control device is interposed between the camshaft and the crankshaft. Consequently, there is the possibility that the phase of the camshaft and that of the crankshaft are not determined uniquely, and fuel injection is performed within the pressurization period of the high-pressure fuel pump 103. Therefore, in the ECU 114A according to the second embodiment, even in the case where the fuel injection is performed in the pressurization period and the fuel pressure drops temporarily, the operation state of the solenoid valve can be determined correctly.

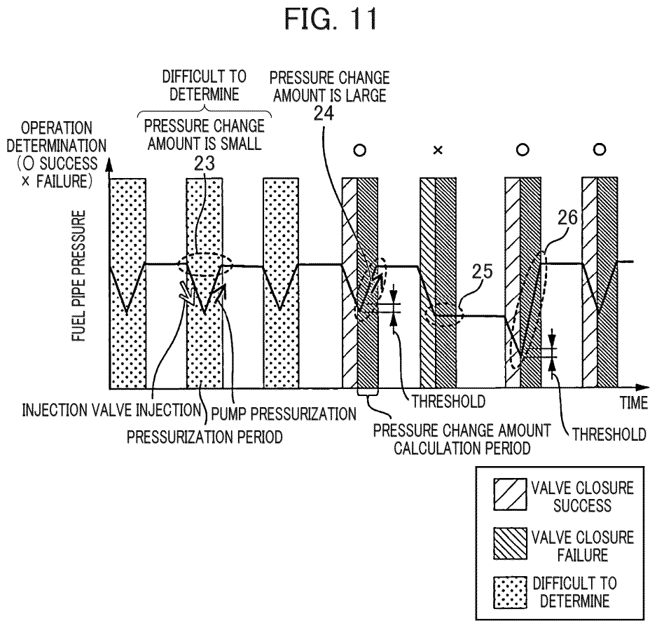

FIG. 11 is a diagram illustrating a state of a fuel pipe pressure in the case where fuel injection is performed in a pressurization period.

In the case of a success in valve closure, by performing fuel injection by the fuel injection valve during the pressurization period, the fuel pipe pressure decreases. After that, the fuel is pressurized, and pressure behavior becomes such that the fuel pressure decreased by the fuel injection in the pressurization period recovers by the pressurization. In the pressurization period of a dotted region 23 in FIG. 11, the pressure change amount is small. When the entire pressurization period is set as a period of calculating the pressure change amount as described above, despite that it is in the pressurization period, a pressure change is hardly seen, and the pressure change amount becomes equal to or less than the threshold. Consequently, it is concerned that the operation determination unit 803 erroneously determines it as a failure of the valve operation, so that the determination of the operation of the solenoid valve is difficult.

To prevent such an erroneous determination, the pressure change calculation unit 802 calculates the pressure change amount in a calculation period from the start of the pressurization period of the high-pressure fuel pump 103, which is immediately after the fuel injection valve injects fuel, until the end of the pressurization period. After that, in the case where injection of the fuel by the injection valve is executed during an intermittent pressurization period of the fuel pump (high-pressure fuel pump 103), the operation determination unit (operation determination unit 803 illustrated in FIG. 7) determines the operation state of the solenoid valve after the injection of the fuel. For example, the operation determination unit 803 uses, for operation determination, whether or not the pressure change amount calculated by the pressure change calculation unit 802 illustrated in a region 24 becomes larger than the threshold. By the process, a pressure decrease amount due to an injection can be excluded and, in the pressurization period in which the pressure change amount is large, the operation determination unit 803 can accurately capture a pressure rise due to pressurization. As a result, it can be expected that the operation determination unit 803 prevents erroneous determination.

In the case where the valve closure fails, as illustrated in a region 25, the pressure change amount does not increase in the calculation period of the pressure change amount. Consequently, the operation determination unit 803 can determine a valve closure failure accurately. After that, as illustrated in a region 26, when the pressure change amount calculated in the calculation period of the pressure change amount exceeds the threshold, the operation determination unit 803 can determine that valve closure succeeds.

The present invention is not limited to the foregoing embodiments and, obviously, can include other various application examples and modification examples without departing from the gist of the present invention described in the scope of claims.

For example, the configurations of the device and the system have been specifically and concretely described to make the present invention easily understood in the foregoing embodiments. The present invention is not always limited to a device having all of the described components. In addition, part of the configuration of one embodiment can be replaced with the configurations of other embodiments, and in addition, the configuration of the one embodiment can also be added with the configurations of other embodiments. In addition, part of the configuration of each of the embodiments can be subjected to addition, deletion, and replacement with respect to other configurations.

The control lines and the information lines which are considered to be necessary for the description are illustrated. All of control and information lines in a product are not always illustrated. It can be considered that most of the components are connected to mutually in practice.

### LIST OF REFERENCE SIGNS

10: direct internal combustion engine
103: high-pressure fuel pump
104: high-pressure pipe
111: low-pressure pipe
114, 111A: ECU
202: plunger
203: inlet valve
204: anchor
205: solenoid
301: discharge rate control unit
302: rotational angle sensor
401: fuel pressure sensor
801: plunger operation determination unit
802: pressure change calculation unit
803: operation determination unit
804: current application amount learning unit
806: learning value memory
807: predetermined value memory
808: operation condition determination unit
809: switching unit,
810: current application amount control unit

1. An internal combustion engine control device for controlling an internal combustion engine having a fuel pump which intermittently pressurizes a fuel and discharges the fuel into a fuel pipe, and a fuel injection valve which injects the fuel intermittently pressurized, the internal combustion engine control device comprising:
a pressure change calculation unit which calculates a pressure change amount in the fuel pipe for each intermittent pressurization of the fuel pump;
an operation determination unit which determines an operation state of a solenoid valve of the fuel pump on the basis of the pressure change amount; and
a current application amount learning unit, in the case where the operation state is determined as a failure of a valve closing operation of the solenoid valve, which changes a current application amount applied to the solenoid valve, and learns a lower limit value of a current application amount by which the valve closing operation of the solenoid valve can be performed.

2. The internal combustion engine control device according to claim 1, wherein
the pressure change calculation unit uses, as an input value, a signal which is synchronized with a rotation phase of a camshaft which drives the fuel pump, and calculates the pressure change amount for each intermittent pressurization of the fuel pump.

3. The internal combustion engine control device according to claim 2, wherein
in the case where injection of the fuel by the injection valve is executed during the intermittent pressurization period of the fuel pump, the operation determination unit determines an operation state of the solenoid valve after injection of the fuel.

4. The internal combustion engine control device according to claim 3, wherein
the current application amount learning unit preliminarily learns the lower limit value while the internal combustion engine is operated.

5. The internal combustion engine control device according to claim 4, wherein
the operation determination unit determines insufficiency of the valve closing operation of the solenoid valve as an operation state of the solenoid valve.

6. The internal combustion engine control device according to claim 3, wherein
the current application amount learning unit preliminarily learns the lower limit value while the internal combustion engine is performing a steady operation.

7. The internal combustion engine control device according to claim 3, further comprising:
an operation condition determination unit which determines an operation condition of the internal combustion engine operated by the fuel pump; and
a switching unit which changes the current application amount of the solenoid valve from a predetermined control value to the lower limit value in a period in which the operation condition determination unit determines that the fuel pump is operated under a noise reduction operation condition.

8. The internal combustion engine control device according to claim 7, wherein
the current application amount learning unit preliminarily learns the lower limit value under a plurality of voltage conditions of the internal combustion engine, and
in the case where the operation condition determination unit determines that the fuel pump is operated under the noise reduction operation condition, the switching unit changes the current application amount of the solenoid valve from a predetermined control value to the lower limit value according to the voltage condition.

9. An internal combustion engine control method for controlling an internal combustion engine having a fuel pump which intermittently pressurizes a fuel and discharges the fuel into a fuel pipe, and a fuel injection valve which injects the fuel intermittently pressurized, the internal combustion engine control method comprising the steps of:
a step of calculating a pressure change amount in the fuel pipe for each intermittent pressurization of the fuel pump;
a step of determining an operation state of a solenoid valve of the fuel pump on the basis of the pressure change amount; and
a step, in the case where the operation state is determined as a failure of a valve closing operation of the solenoid valve, of changing a current application amount applied to the solenoid valve, and learning a lower limit value of a current application amount by which the valve closing operation of the solenoid valve can be performed.
